(19) United States
(12) Patent Application Publication
(10) Pub. No.: US 2024/0006689 A1
(43) Pub. Date: Jan. 4, 2024

(54) BATTERY HOUSINGS

(71) Applicant: Apple Inc., Cupertino, CA (US)

(72) Inventors: Daeshin Lee, San Jose, CA (US); Joshua M. Chien, Menlo Park, CA (US); Rajesh Kandibanda, Los Gatos, CA (US); Aniruddha M. Bhokarikar, Sunnyvale, CA (US); Mark E. Wilcox, Morgan Hill, CA (US); Seth M. Spaude, Kenosha, WI (US); Steven M. Labovitz, Sunnyvale, CA (US)

(21) Appl. No.: 18/136,174

(22) Filed: Apr. 18, 2023

Related U.S. Application Data
(60) Provisional application No. 63/357,539, filed on Jun. 30, 2022.

(51) Int. Cl. H01M 50/107; H01M 50/169; H01M 50/148

(52) U.S. Cl. CPC H01M 50/107; H01M 50/169; H01M 50/148

(57) ABSTRACT

A housing of a battery may be produced to have a reduced flange, such that an interior volume of the housing is increased. The housing may include a can and a cover welded to one another to form a flange of the housing. The cover may be generally planar, and the can may include a curved portion and a planar portion extending from the curved portion. The planar portion may be welded to the cover to form the flange. A weld seam between the can and the cover may begin generally at an end of the planar portion of the can adjacent to the curved portion, and the flange may be cut along or adjacent to the weld seam. In particular, a distance between a transition point of the curved portion of the can and an outermost end of the flange may be less than 300 microns.

### CROSS-REFERENCE TO RELATED APPLICATIONS

This application claims priority to U.S. Provisional Application No. 63/357,539, filed Jun. 30, 2022, entitled “BATTERY HOUSINGS,” the disclosure of which is incorporated by reference in its entirety for all purposes.

### BACKGROUND

The present disclosure relates generally to battery housings, and more specifically to battery housings having a reduced flange to increase an interior volume of the battery housings.

A battery may include a housing, electrode material (e.g., an anode, a cathode) disposed in the housing, terminals protruding from the housing, and other possible componentry. The battery may be employed as a source of power for an electronic device. An interior volume of the housing may limit an amount of power that the battery may provide for the electronic device. For example, a volumetric energy density of the electrode material in the housing may be limited by a size of the interior volume of the housing. Further, an interior volume of the electronic device may limit a size of the battery.

Additionally, certain batteries include a flange along an exterior of the housing. The flange may facilitate manufacturing of the battery, such as by coupling multiple components (e.g., a can and a cover) to one another to form the flange and the housing generally. The flange may extend along an exterior of the housing. Because the flange may occupy space within the electronic device allocated to the battery, the flange may reduce the interior volume of the housing and the volumetric energy density of the battery. For at least these reasons, among others, improved batteries and battery manufacturing techniques are desired.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, a battery housing includes a cover and a can. The can includes a curved portion having a transition point and a planar portion extending from the curved portion. The planar portion is coupled to the cover via a weld seam to form a flange. A distance between the transition point of the curved portion and an outermost end of the flange is equal to or less than 300 microns.

In another embodiment, a battery includes a cover, a can, and electrode material disposed within a cavity formed between cover and the can. The can includes a curved portion having a transition point, and the cover and the can form a flange. A distance between the transition point of the curved portion and an outermost end of the flange is equal to or less than 300 microns.

In yet another embodiment, a battery includes a housing and electrode material disposed within the housing. The housing includes a curved portion having a transition point and a flange extending from the curved portion. A distance between the transition point of the curved portion and an outermost end of the flange is equal to or less than 300 microns.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of an electronic device, according to embodiments of the present disclosure;

FIG. 2 is an exploded perspective view of a battery employed to power the electronic device of FIG. 1, where the battery includes electrode material and a housing having a can and a cover, according to embodiments of the present disclosure;

FIG. 3 is a block diagram of a battery housing generation system employed to generate the housing of the battery of FIG. 2, according to embodiments of the present disclosure;

FIG. 4 is a side cross-sectional view of the can and the cover of the housing of FIG. 2 clamped to one another via the battery housing generation system of FIG. 3, according to embodiments of the present disclosure;

FIG. 5 is a side cross-sectional view of the can and the cover of FIG. 2 welded to one another via the battery housing generation system of FIG. 3, according to embodiments of the present disclosure;

FIG. 6 is a side view of the can of FIG. 2 disposed on a platform for measuring a thickness of the can via the battery housing generation system of FIG. 3, according to embodiments of the present disclosure;

FIG. 7 is a side view of the cover of FIG. 2 disposed on a platform for measuring a thickness of the cover via the battery housing generation system of FIG. 3, according to embodiments of the present disclosure;

FIG. 8 is a side view of the can and the cover of FIG. 2 clamped to one another and disposed on a platform for measuring a combined thickness of the can and the cover via the battery housing generation system of FIG. 3, according to embodiments of the present disclosure;

FIG. 9 is a side view of the can and the cover of FIG. 2 clamped to one another illustrating movement of clamps for welding the can and the cover to one another and cutting a flange formed by the welded can and cover via the battery housing generation system of FIG. 3, according to embodiments of the present disclosure;

FIG. 10 is a flowchart of a method of adjusting a pressure applied by clamps to the can and the cover of FIG. 2 that may be performed via the battery housing generation system of FIG. 3, according to embodiments of the present disclosure; and

FIG. 11 is a flowchart of a method of welding the can and the cover of FIG. 2 and cutting a flange formed by the can and the cover via the battery housing generation system of FIG. 3, according to embodiments of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on.

This disclosure relates generally to a housing of a battery employed to power an electronic device. The battery may include the housing and electrode material disposed in the housing. An interior volume of the electronic device may limit a size and an interior volume of the battery, which may limit an amount of power (e.g., defined by a volumetric energy density) that may be provided to the electronic device by the battery. The housing may include a flange to facilitate manufacturing of the housing, such as by coupling multiple components (e.g., a can and a cover) together to form the flange and the housing generally. The flange may further limit the interior volume of the battery and the amount of power that may be provided to the electronic device by the battery. For example, the flange may be disposed along a perimeter of the housing and occupy space allocated to the battery within the electronic device.

Embodiments herein provide a housing of a battery having a reduced flange, such that an interior volume of the housing is increased. In particular, the housing may include a can and a cover that form a cavity for receipt of electrode material of the battery. The can and the cover may be welded to one another to form the housing and the flange along a perimeter of the housing. The cover may be generally planar, and the can may include a curved portion and a planar portion extending from the curved portion along a perimeter of the can. The planar portion of the can may be welded to the cover to form the flange. To reduce a length of the flange, a weld seam between the can and the cover may begin generally at an end of the planar portion of the can adjacent to the curved portion, and the flange may be cut along or adjacent to the weld seam.

To provide the reduced flange and a hermetic seal at the weld seam, thicknesses of the can (e.g., the planar portion of the can) and the cover may be individually measured. The can and the cover may be clamped to one another, and the clamped (e.g., combined) can and cover may be measured to determine a gap between the can and the cover. In response to the gap exceeding or being equal to a threshold value, a pressure applied to the clamped can and cover may be adjusted until the gap does not exceed the threshold value. Ensuring that the gap does not exceed the threshold value enables the combined can and cover to maintain the hermetic seal once welded.

After determining that the gap between the clamped can and cover does not exceed not exceed the threshold value, a location of the weld seam between the can and the cover may be determined. For example, a transition point of the curved portion of the can (e.g., a radius start location or a location in which the curved portion begins to curve in a different direction) and a zero position datum of the can (e.g., a radius end location or a location in which the curved portion ends and the planar portion begins) may be determined. The zero position datum of the can may correspond to a start of the gap between the can and the cover described above (e.g., a location where the can and the cover begin to extend generally parallel to one another). The location of the weld seam may be determined based on the zero position datum of the can. For example, an initial path of the weld seam along the perimeter of the combined can and cover may be adjusted based on the zero position datum of the can to ensure that the combined can and cover are welded to one another outside the zero position datum, thereby ensuring that the welded can and cover provide the hermetic seal. After welding the can and the cover together, the flange formed by the can and the cover may be cut, such as along the weld seam (e.g., along a middle of the weld seam) or adjacent to the weld seam (e.g., beyond the weld seam, on a side of the weld seam opposite the curved portion of the can).

The process described herein may provide a reduced flange length (e.g., a distance between the transition point of the curved portion of the can and an outermost edge of the flange). For example, the flange length may be equal to or less than 300 microns, while traditional embodiments may be greater than 600 microns. Accordingly, the reduced flange length may provide for an increased interior volume of the housing, thereby increasing the volumetric energy density of the battery.

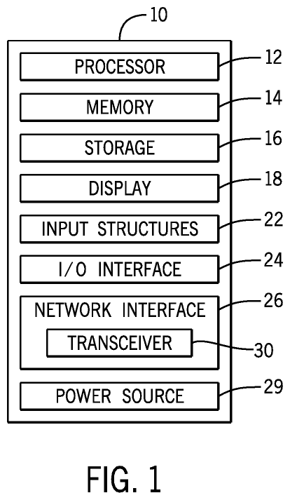

FIG. 1 is a block diagram of an electronic device 10, according to embodiments of the present disclosure. The electronic device 10 may include, among other things, one or more processors 12 (collectively referred to herein as a single processor for convenience, which may be implemented in any suitable form of processing circuitry), memory 14, nonvolatile storage 16, a display 18, input structures 22, an input/output (I/O) interface 24, a network interface 26, and a power source 29. The various functional blocks shown in FIG. 1 may include hardware elements (including circuitry), software elements (including machine-executable instructions) or a combination of both hardware and software elements (which may be referred to as logic). The processor 12, memory 14, the nonvolatile storage 16, the display 18, the input structures 22, the input/output (I/O) interface 24, the network interface 26, and/or the power source 29 may each be communicatively coupled directly or indirectly (e.g., through or via another component, a communication bus, a network) to one another to transmit and/or receive data between one another. It should be noted that FIG. 1 is merely one example of a particular implementation and is intended to illustrate the types of components that may be present in the electronic device 10.

By way of example, the electronic device 10 may include any suitable computing device, including a desktop or notebook computer (e.g., in the form of a MacBook®, MacBook® Pro, MacBook Air®, iMac®, Mac® mini, or Mac Pro® available from Apple Inc. of Cupertino, California), a portable electronic or handheld electronic device such as a wireless electronic device or smartphone (e.g., in the form of a model of an iPhone® available from Apple Inc. of Cupertino, California), a tablet (e.g., in the form of a model of an iPad® available from Apple Inc. of Cupertino, California), a wearable electronic device (e.g., in the form of an Apple Watch® by Apple Inc. of Cupertino, California), and other similar devices. It should be noted that the processor 12 and other related items in FIG. 1 may be embodied wholly or in part as software, hardware, or both. Furthermore, the processor 12 and other related items in FIG. 1 may be a single contained processing module or may be incorporated wholly or partially within any of the other elements within the electronic device 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may include one or more application processors, one or more baseband processors, or both, and perform the various functions described herein.

In the electronic device 10 of FIG. 1, the processor 12 may be operably coupled with a memory 14 and a nonvolatile storage 16 to perform various algorithms. Such programs or instructions executed by the processor 12 may be stored in any suitable article of manufacture that includes one or more tangible, computer-readable media. The tangible, computer-readable media may include the memory 14 and/or the nonvolatile storage 16, individually or collectively, to store the instructions or routines. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the electronic device 10 to provide various functionalities.

In certain embodiments, the display 18 may facilitate users to view images generated on the electronic device 10. In some embodiments, the display 18 may include a touch screen, which may facilitate user interaction with a user interface of the electronic device 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 22 of the electronic device 10 may enable a user to interact with the electronic device 10 (e.g., pressing a button to increase or decrease a volume level). The I/O interface 24 may enable electronic device 10 to interface with various other electronic devices, as may the network interface 26. In some embodiments, the I/O interface 24 may include an I/O port for a hardwired connection for charging and/or content manipulation using a standard connector and protocol, such as the Lightning connector provided by Apple Inc. of Cupertino, California, a universal serial bus (USB), or other similar connector and protocol. The network interface 26 may include, for example, one or more interfaces for a personal area network (PAN), such as an ultra-wideband (UWB) or a BLUETOOTH® network, a local area network (LAN) or wireless local area network (WLAN), such as a network employing one of the IEEE 802.11x family of protocols (e.g., WI-FI®), and/or a wide area network (WAN), such as any standards related to the Third Generation Partnership Project (3GPP), including, for example, a 3^{rd} generation (3G) cellular network, universal mobile telecommunication system (UMTS), 4^{th} generation (4G) cellular network, long term evolution (LTE®) cellular network, long term evolution license assisted access (LTE-LAA) cellular network, 5^{th} generation (5G) cellular network, and/or New Radio (NR) cellular network, a 6^{th} generation (6G) or greater than 6G cellular network, a satellite network, a non-terrestrial network, and so on. In particular, the network interface 26 may include, for example, one or more interfaces for using a cellular communication standard of the 5G specifications that include the millimeter wave (mmWave) frequency range (e.g., 24.25-300 gigahertz (GHz)) that defines and/or enables frequency ranges used for wireless communication.

The network interface 26 of the electronic device 10 may allow communication over the aforementioned networks (e.g., 5G, Wi-Fi, LTE-LAA, and so forth).

The network interface 26 may also include one or more interfaces for, for example, broadband fixed wireless access networks (e.g., WIMAX®), mobile broadband Wireless networks (mobile WIMAX®), asynchronous digital subscriber lines (e.g., ADSL, VDSL), digital video broadcasting-terrestrial (DVB-T®) network and its extension DVB Handheld (DVB-H®) network, ultra-wideband (UWB) network, alternating current (AC) power lines, and so forth.

As illustrated, the network interface 26 may include a transceiver 30. In some embodiments, all or portions of the transceiver 30 may be disposed within the processor 12. The transceiver 30 may support transmission and receipt of various wireless signals via one or more antennas, and thus may include a transmitter and a receiver. The power source 29 of the electronic device 10 may include any suitable source of power, such as a rechargeable lithium polymer (Li-poly) battery and/or an alternating current (AC) power converter.

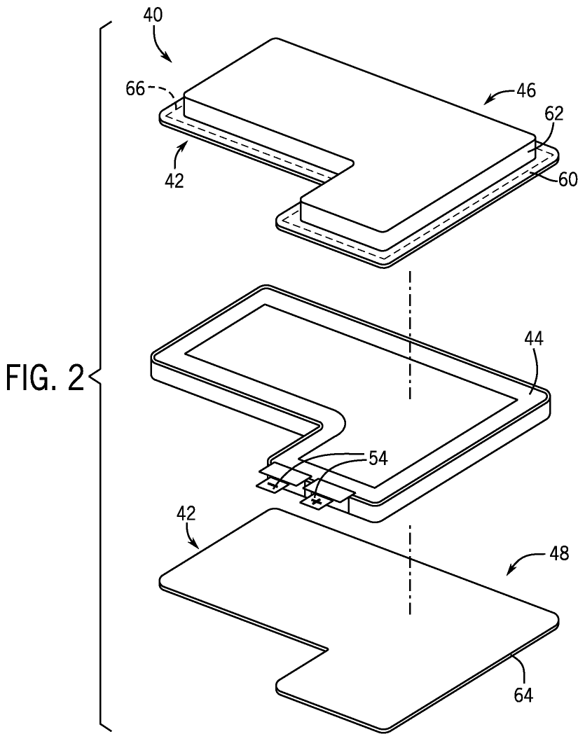

FIG. 2 is an exploded perspective view of a battery 40 employed to power the electronic device 10 of FIG. 1, according to embodiments of the present disclosure. In particular, the battery may be an example of the power source 29 of the electronic device 10. As illustrated, the battery 40 includes a housing 42 and electrode material 44. The housing 42 includes a can 46 and a cover 48. The can 46 and the cover 48 may form a cavity for receipt of the electrode material 44. For example, as described herein, the can 46 and the cover 48 may be welded to one another to form the housing 42 and the cavity within the housing 42, and the electrode material may be injected into the cavity. In certain embodiments, the can 46 and/or the cover 48 may be stamped components. Additionally, the can 46 and/or the cover 48 may stainless steel and/or other suitable materials.

The electrode material 44 may include an electrode stack assembly, such as a stacked anode and cathode, that provide power to the electronic device 10. Additionally, the battery 40 may include terminals 54 (e.g., a positive terminal, a negative terminal) coupled to the electrode material 44 that provide power connections (e.g., enable electrically coupling) between the electrode material 44 and the electronic device 10.

The housing 42 may include a flange formed upon welding of the can 46 and the cover 48. For example, the flange may include a planar portion 60 (e.g., an outer portion) of the can 46 that extends from a curved portion 62 of the can 46. Additionally, the flange may include an outer portion 64 of the cover 48. As illustrated, the cover 48 is generally planar. The can 46 and the cover 48 may be welded along a dashed line 66 shown along the planar portion 60 of the can 46. Upon welding of the can 46 and the cover 48, the flange may be cut to reduce a size (e.g., a surface area, a footprint) of the housing 42 and the battery 40 generally.

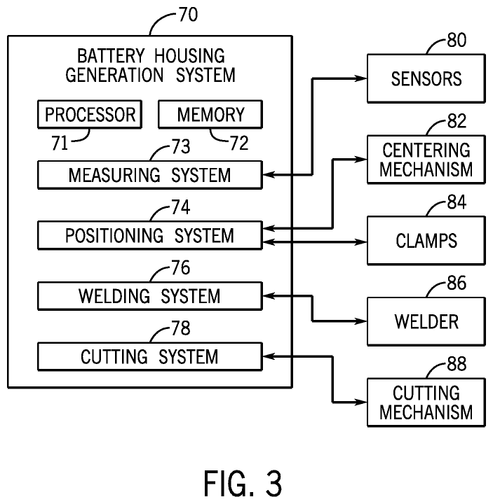

With the foregoing in mind, FIG. 3 is a block diagram of a battery housing generation system 70 employed to generate the housing 42 of the battery 40 of FIG. 2, according to embodiments of the present disclosure. The battery housing generation system 70 may include a processor 71 and a memory 72, which may be similar to the processor 12 and the memory 14 of the electronic device 10, respectively. Additionally, the battery housing generation system 70 may include a measuring system 73, a positioning system 74, a welding system 76, and a cutting system 78. The measuring system 73, the positioning system 74, the welding system 76, and/or the cutting system 78 may include hardware elements and/or software elements similar to those described above in reference to the electronic device 10 of FIG. 1. In certain embodiments, the measuring system 73, the positioning system 74, the welding system 76, and/or the cutting system 78 may communicate with and/or include additional hardware elements that enable the respective systems to perform certain functions. For example, the measuring system 73 may communicate with and/or include sensors 80 (e.g., measurement sensors) and/or devices that facilitate measuring the can 46 and the cover 48 with the sensors 80. The sensors 80 may include a displacement sensor (e.g., a confocal displacement sensor), a two-dimensional scanner/profiler, a three-dimensional scanner/profiler, a voice coil actuator, and/or other suitable sensors. The positioning system 74 may communicate with and/or include a centering mechanism 82 that facilitates centering of the can 46 and the cover 48 relative to one another and/or relative to another structure (e.g., a platform, a fixture). In certain embodiments, the positioning system 74 may communicate with and/or include one or more clamps 84 (and/or actuators) that clamp (e.g., secure, apply pressure) the can 46 and the cover 48 to one another. The welding system 76 may communicate with and/or include a welder 86 (e.g., a laser welder, a welding tool) that facilitates welding of the can 46 and the cover 48 to one another. The cutting system 78 may communicate with and/or include a cutting mechanism 88 (e.g., a laser, a mechanical cutter) that facilitates cutting of the components. In certain embodiments, the battery housing generation system 70 may provide communicative connections between the measuring system 73, the positioning system 74, the welding system 76, and the cutting system 78 and/or may control the measuring system 73, the positioning system 74, the welding system 76, and the cutting system 78, such as via instructions stored in the memory 72 that are executable by the processor 71. In certain embodiments, one or more of the measuring system 73, the positioning system 74, the welding system 76, and the cutting system 78 may be omitted from the battery housing generation system 70.

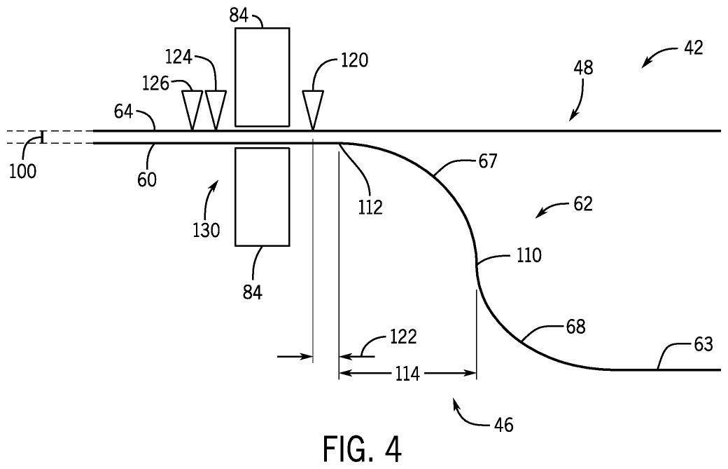

FIG. 4 is a side cross-sectional view of the can 46 and the cover 48 of FIG. 2 clamped to one another via the clamps 84, according to embodiments of the present disclosure. For simplicity, only portions of the cross-sections of the can 46 and the cover 48 are shown in FIG. 3. As described above, thicknesses of the planar portion 60 of the can 46 and the outer portion 64 of the cover 48 (e.g., near an edge of the cover 48) may be individually measured. For example, the sensors 80 of the measuring system 73 may measure (e.g., detect) a thickness of the planar portion 60 of the can 46 and a thickness of the outer portion 64 of the cover 48 at multiple locations (e.g., two locations or more, such as three locations, four locations, five locations, six locations, ten locations, twenty locations, fifty locations, and so on) along respective perimeters of the planar portion 60 of the can 46 and the outer portion 64 of the cover 48.

The cover 48 may then be disposed on the can 46 (e.g., above or on top of the can 46) while the can 46 is disposed on a platform (e.g., a fixture). The positioning system 74 may position the cover 48 relative to the can 46. For example, the centering mechanism 82 may center the cover 48 relative to the can 46. In certain embodiments, the can 46 may be disposed on the cover 48 (e.g., above or on top of the cover 48) while the cover 48 is disposed on a platform. The positioning system 74 may position the can 46 relative to the cover 48, such that the positioning system 74 centers the can 46 on the cover 48.

The clamps 84 may apply pressure to the can 46 and the cover 48 (e.g., squeezing the can 46 and the cover 48 together) at the planar portion 60 of the can 46 and the outer portion 64 of the cover 48. The sensors 80 may measure a combined thickness of the planar portion 60 of the can 46 and the outer portion 64 of the cover 48, such as before or after application of pressure by the clamps 84. The battery housing generation system 70 may receive the measurement of the combined thickness of the planar portion 60 of the can 46 and the outer portion 64 of the cover 48 and, via the measuring system 73 and/or the positioning system 74, may determine a gap 100 between the planar portion 60 of the can 46 and the outer portion 64 of the cover 48. For example, the battery housing generation system 70 may determine the gap 100 based on the combined thickness of the planar portion 60 of the can 46 and the outer portion 64 of the cover 48, the thickness of the planar portion 60 of the can 46 individually, and the thickness of the outer portion 64 of the cover 48 individually. In particular, the battery housing generation system 70 may determine the gap 100 as a difference between the combined thickness of the planar portion 60 of the can 46 and the outer portion 64 of the cover 48 and a sum the thickness of the planar portion 60 of the can 46 and the thickness of the outer portion 64 of the cover 48.

In response to determining that the gap 100 exceeds a threshold value (e.g., a threshold distance), the battery housing generation system 70 may, via the positioning system 74, adjust the pressure applied by the clamps 84 to the planar portion 60 of the can 46 and the outer portion 64 of the cover 48. The battery housing generation system 70 may receive an additional measurement of the combined thickness of the planar portion 60 of the can 46 and the outer portion 64 of the cover 48 and continue to adjust the pressure applied by the clamps 84 until the gap 100 does not exceed the threshold value. The battery housing generation system 70 may determine the threshold value based on a type of material of the can 46, a type of material of the cover 48, the combined thickness of the planar portion 60 of the can 46 and the outer portion 64 of the cover 48, the thickness of the planar portion 60 of the can 46 individually, the thickness of the outer portion 64 of the cover 48 individually, and/or other suitable factors. The threshold value may include 2000 microns or less, such as 1000 microns, 600 microns, 500 microns, 400 microns, 300 microns, 200 microns, 100 microns, or another suitable value. Ensuring that the gap 100 does not exceed the threshold value may enable the can 46 and the cover 48 to maintain a hermetic seal of a cavity between the can 46 and the cover 48 once welded. For example, the threshold value may generally correspond to a maximum gap between the planar portion 60 of the can 46 and the outer portion 64 of the cover 48 that may be reliably sealed once welded.

The can 46 may include a transition point 110 (e.g., a curve transition point) and a zero position datum (ZPD) 112 at the curved portion 62. The transition point 110 may refer to a point or location on the curved portion 62 where a first subportion 67 of the curved portion 62, having a first arcuate direction, transitions to a second subportion 68 of the curved portion 62, having a second, different, arcuate direction. The transition point 110 may alternatively or additionally include a reflection location along the curved portion 62 of the can 46 at which the first subportion 67 of the curved portion 62 reflects a second subportion 68 of the curved portion 62, where the second subportion 68 may be inverted from the first subportion 67 (e.g., by 180°). As another example, the transition point 110 may be a vertical midpoint between the planar portion 60 of the can 46 (e.g., a first planar portion) and a second planar portion 63 of the can 46.

The ZPD 112 may include a location along the can 46 wherein the can 46 begins to extend generally straight (e.g., at 180°). For example, the ZPD 112 may include a tangent point of the curved portion 62 and/or an end of the curved portion 62. In certain embodiments, the can 46 may begin to extend along (e.g., generally parallel to) the cover 48 at the ZPD 112. Additionally or alternatively, the ZPD 112 may include a location at which the end of the curved portion 62 is connected to an end of the planar portion 60.

A distance 114 between the transition point 110 and the ZPD 112 may include 200 microns or less, such as 100 microns, 80 microns, 60 microns, 40 microns, 20 microns, or another suitable value. Additionally, the distance 114 may vary based on formation (e.g., stamping) of the can 46. For example, a tolerance of the distance 114 may include 80 microns or less, such as 70 microns, 60 microns, 50 microns, 40 microns, 30 microns, 20 microns, 10 microns, 5 microns, or another suitable value.

The battery housing generation system 70, via the measuring system 73 and/or the sensors 80, may determine or identify locations of the transition point 110 and the ZPD 112 along a profile of the can 46. For example, one or more of the sensors 80 may scan the profile to identify the locations of the transition point 110 and the ZPD 112. The measuring system 73 may measure the transition point 110 and the ZPD 112, such as by measuring the distance 114 between the transition point 110 and the ZPD 112.

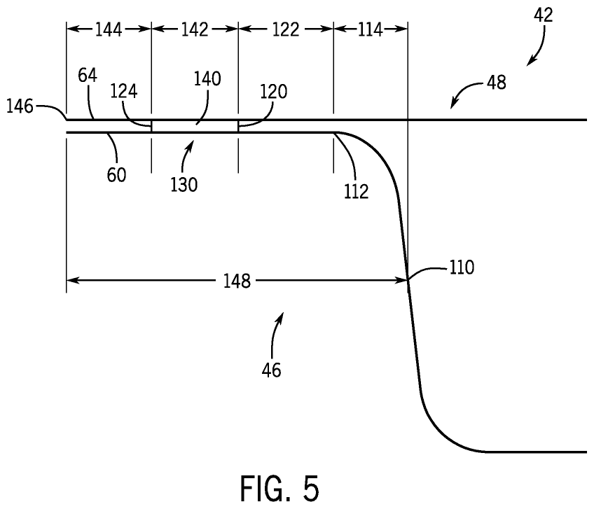

To weld the can 46 and the cover 48 to one another, the welding system 76 may provide a predefined weld path for the welder 86 along the can 46 and the cover 48 (e.g., along the planar portion 60 of the can 46 and the outer portion 64 of the cover 48). The welding system 76 may adjust the predefined weld path based on the location of the ZPD 112 to generate a new weld location. For example, the welding system 76 may determine a location of an inner edge 120 of a weld seam (e.g., the new weld location) that is beyond the ZPD 112 (e.g., closer to an outermost edge of the can 46 and/or the cover 48 relative to the ZPD 112) and within a threshold distance of the ZPD 112. Ensuring that the inner edge 120 of the weld seam is beyond the ZPD 112 may enable the can 46 and the cover 48 to maintain the hermetic seal of the battery 40. For example, the inner edge 120 of the weld seam may be at a location in which the gap 100 is determined to be less than the threshold value described above. Additionally, ensuring that the inner edge 120 of the weld seam is within the threshold distance of the ZPD 112 may reduce a size of a flange 130 formed by the planar portion 60 of the can 46 and the outer portion 64 of the cover 48 once welded. A distance 122 between the ZPD 112 and the inner edge 120 of the weld seam may include 100 microns or less, such as 80 microns, 60 microns, 40 microns, 20 microns, 10 microns, or another suitable value. Additionally, a tolerance of the distance 122 may include 100 microns or less, such as 80 microns, 77 microns, 70 microns, 60 microns, 50 microns, 40 microns, 30 microns, 20 microns, 10 microns, 5 microns, or another suitable value. As described in reference to FIG. 5, an outer edge 124 of the weld seam may include the planar portion 60 of the can 46 and/or the outer portion 64 of the cover 48, such that the weld seam extends between the inner edge 120 and the outer edge 124.

In certain embodiments, the welding system 76 may adjust a power provided to the welder 86 to generate the weld seam based on the gap 100. For example, the welding system 76 may decrease the power provided to the welder 86 based on a reduced size of the gap 100, and vice versa. As described herein, the battery housing generation system 70 may determine the gap 100 at multiple locations along the planar portion 60 of the can 46 and the outer portion 64 of the cover 48. As such, as the size of the gap 100 varies, the welding system 76 may vary the power provided to the welder 86 to generate the weld seam. Accordingly, the welding system 76 may reduce a potential for pooling of material along the weld seam. In additional or alternative embodiments, the battery housing generation system 70 may determine a mathematical function (e.g., mean, median, mode, minimum, maximum, or the like) of the multiple measurements of the gap 100, and adjust the welder 86 based on mathematical function.

The planar portion 60 of the can 46 and the outer portion 64 of the cover 48 may form the flange 130 of the housing 42 upon welding the planar portion 60 of the can 46 to the outer portion 64 of the cover 48. The cutting system 78 may cut the flange 130 at a cut location 126, such as via the cutting mechanism 88. As illustrated, the cut location 126 is beyond the outer edge 124 of the weld seam (e.g., closer to an outermost edge of the flange 130 relative to the ZPD 112). In certain embodiments, the cut location 126 may be along the weld seam (e.g., between the inner edge 120 and the outer edge 124 of the weld seam, halfway between the inner edge 120 and the outer edge 124 of the weld seam, and so on). For example, the clamps 84 may be moved along the flange 130 and/or may be removed, such that the cutting mechanism 88 is able to cut the flange 130 between the inner edge 120 and the outer edge 124 of the weld seam. In certain embodiments, the cutting mechanism 88 may cut the flange 130 between the inner edge 120 and the outer edge 124 of the weld seam while the clamps 84 remain in place. The flange 130 may maintain the hermetic seal formed by the weld seam whether the cut location 126 is beyond the outer edge 124 of the weld seam, as shown in FIG. 4, or the cut location 126 is between the inner edge 120 and the outer edge 124 of the weld seam.

Accordingly, the battery housing generation system 70 may generate the housing 42 to have the flange 130 with a reduced length. In particular, the battery housing generation system 70 may determine and adjust the gap 100, determine the ZPD 112, adjust the weld seam location based on the ZPD 112, and/or adjust the weld power based on the gap 100 to produce the flange 130. The battery housing generation system 70 may cut the flange 130 to the reduced length while maintaining the hermetic seal, thereby providing an increased interior volume of the housing 42 and an increased volumetric density of the battery 40.

FIG. 5 is a side cross-sectional view of the can 46 and the cover 48 of FIG. 2 welded to one another via the battery housing generation system 70 of FIG. 3, according to embodiments of the present disclosure. As illustrated, the flange 130 of the housing 42 includes a weld seam 140 coupling the can 46 and the cover 48 to one another. To better demonstrate the reduced length of the flange 130, example dimensions and tolerances of the flange 130 and portions of the flange 130 are provided. For example, the distance 114 between the transition point 110 and the ZPD 112 and potential tolerances of the distance 114 are described in reference to FIG. 4. The distance 122 between the ZPD 112 and the inner edge 120 of the weld seam 140 and potential tolerances of the distance 122 are also described in reference to FIG. 4.

A distance 142 between the inner edge 120 of the weld seam 140 and the outer edge 124 of the weld seam 140 (e.g., a length of the weld seam 140) may include 200 or less microns, such as 100 microns, 80 microns, 60 microns, 40 microns, 20 microns, or another suitable value. Additionally, a tolerance of the distance 142 may include 60 microns or less, such as 50 microns, microns, 30 microns, 20 microns, 10 microns, 5 microns, or another suitable value. The distance 142 and/or the tolerance of the distance 142 may depend on a type of the welder 86, among other factors.

A distance 144 between the outer edge 124 of the weld seam 140 and an outermost edge 146 of the flange 130 may include 40 microns or less, such as 30 microns, 20 microns, 10 microns, 5 microns, or another suitable value. Additionally, a tolerance of the distance 142 may include 10 microns or less, such as 8 microns, 6 microns, 5 microns, 4 microns, 3 microns, 2 microns, 1 micron, or another suitable value.

In certain embodiments, the weld seam 140 may extend to the outermost edge 146 of the flange 130. For example, the flange 130 may be cut along the weld seam 140 (e.g., a portion, such as half, of the weld seam 140 may be cut off from the flange 130).

A distance 148 between the transition point 110 and the outermost edge of the flange 130 may include the distance 114, the distance 122, the distance 142, and the distance 144. The distance 148 may include 450 microns or less, such as 400 microns, 350 microns, 300 microns, 250 microns, 200 microns, 150 microns, 100 microns, 50 microns, 20 microns, or another suitable value. Additionally, a tolerance of the distance 148 may include 200 microns or less, such as 150 microns, 114 microns, 100 microns, 80 microns, 50 microns, or another suitable value.

The battery housing generation system 70 may generate the housing 42 to have the reduced size (e.g., the distance 148) of the flange 130 via the processes described herein. For example, the distance 148 may be less than 300 microns, such that the flange 130 is smaller than traditional embodiments. Accordingly, the battery housing generation system 70 may reduce the size of the flange 130, thereby providing an increased interior volume of the housing 42 and an increased volumetric density of the battery 40.

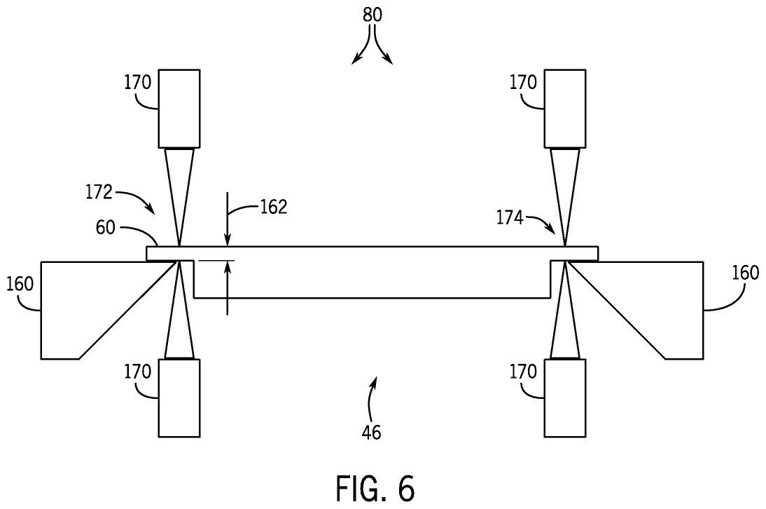

FIG. 6 is a side view of the can 46 of FIG. 2 disposed on a platform 160 for measuring a thickness 162 of the planar portion 60 the can 46 via the battery housing generation system 70 of FIG. 3, according to embodiments of the present disclosure. The measuring system 73 may measure the thickness 162 of the planar portion 60 via the sensors 80. For example, the sensors may include displacement sensors 170 (e.g., one-dimensional displacement sensors) that measure the thickness 162.

As described herein, the measuring system 73 may measure the thickness 162 at multiple locations along the planar portion 60 the can 46. In the illustrated embodiment, the measuring system 73 measures the thickness 162 at a first location 172 and a second location 174. In other embodiments, the measuring system 73 may measure the thickness 162 at additional locations (e.g., three locations or more, such as four locations, five locations, six location, ten locations, twenty locations, fifty locations, or the like). The measuring system 73 may provide feedback indicative of the thickness 162 at each location along the planar portion 60 of the can 46 to the battery housing generation system 70.

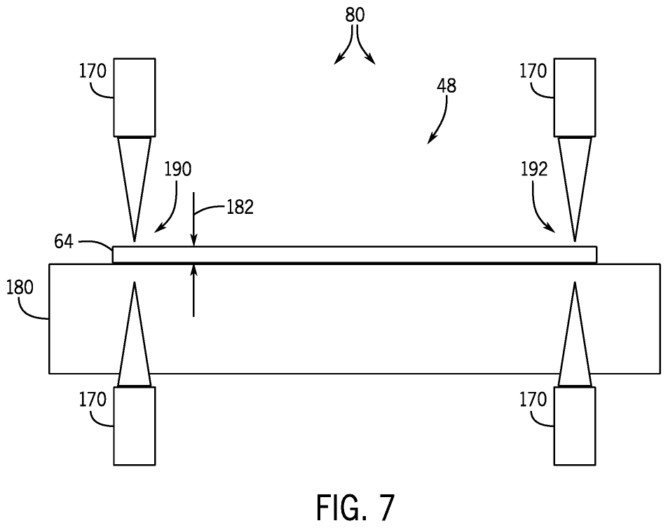

FIG. 7 is a side view of the cover 48 of FIG. 2 disposed on a platform 180 for measuring a thickness 182 of the outer portion 64 of the cover 48 via the battery housing generation system of FIG. 3, according to embodiments of the present disclosure. The measuring system 73 may measure the thickness 182 of the outer portion 64 via the sensors 80. For example, the displacement sensors 170 may measure the thickness 182.

As described herein, the measuring system 73 may measure the thickness 182 at multiple locations along the outer portion 64 of the cover 48. In the illustrated embodiment, the measuring system 73 measures the thickness 182 at a first location 190 and a second location 192. In other embodiments, the measuring system 73 may measure the thickness 182 at additional locations (e.g., three locations or more, such as four locations, five locations, six location, ten locations, twenty locations, fifty locations, or the like). The measuring system 73 may provide feedback indicative of the thickness 182 at each location along the outer portion 64 of the cover 48 to the battery housing generation system 70.

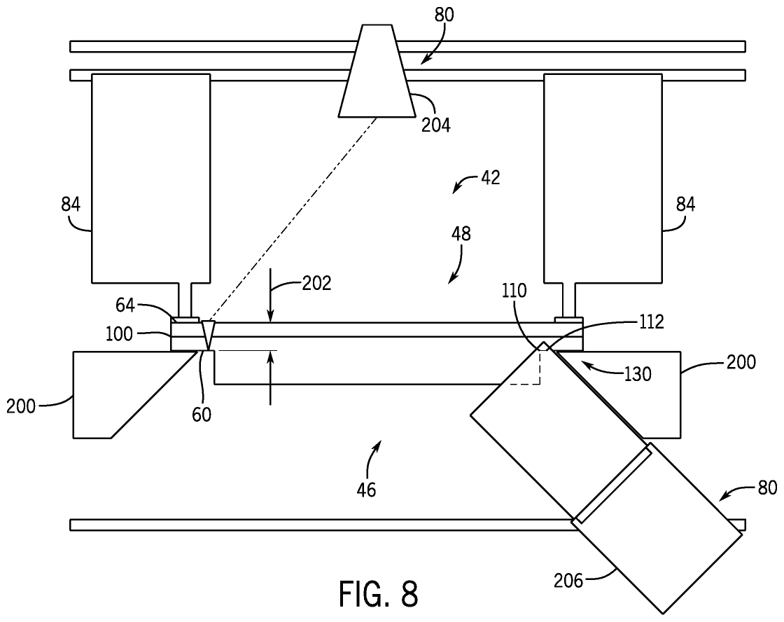

FIG. 8 is a side view of the can 46 and the cover 48 of FIG. 2 clamped to one another and disposed on a platform 200 for measuring a thickness 202 (e.g., a combined thickness) of the planar portion 60 of the can 46 and the outer portion 64 of the cover 48 via the battery housing generation system 70 of FIG. 3, according to embodiments of the present disclosure. In certain embodiments, the platform 200 may include the platform 160 shown in FIG. 6. The positioning system 74, via the centering mechanism 82, may center the cover 48 on the can 46. Additionally, the positioning system 74, via the clamps 84, may apply pressure to the planar portion 60 of the can 46 and the outer portion 64 of the cover 48 while the planar portion 60 of the can 46 and the outer portion 64 of the cover 48 are disposed between the clamps 84 and the platform 200. For example, the clamps 84 may press the planar portion 60 of the can 46 and the outer portion 64 of the cover 48 against the platform 200.

The sensors 80 may include a sensor 204 (e.g., a voice coil actuator) that measures the thickness 202 of the planar portion 60 of the can 46 and the outer portion 64 of the cover 48. The sensor 204 may measure the thickness 202 at one or more locations (e.g., each location) where the thickness 162 of the planar portion 60 of the can 46 and the thickness 182 of the outer portion 64 of the cover 48 were previously measured, such as at the locations 172, 174, 190, and 192 described in reference to FIGS. 6 and 7. In additional or alternative embodiments, the sensor 204 may measure the thickness 202 at different locations than those previously measured. The sensor 204 may provide feedback indicative of the thickness 202 at each location to the battery housing generation system 70.

The battery housing generation system 70 may receive the feedback indicative of the thickness 202 and determine the gap 100 based on the thickness 202, the thickness 162 of the planar portion 60 of the can 46, and/or the thickness 182 of the outer portion 64 of the cover 48. In response to determining that the gap 100 exceeds a threshold value, the battery housing generation system 70 may, via the positioning system 74, adjust the pressure applied by the clamps 84 to the planar portion 60 of the can 46 and the outer portion 64 of the cover 48. The battery housing generation system 70 may receive an additional measurement of the thickness 202 from the sensor 204 and continue to adjust the pressure applied by the clamps 84 until the gap 100 does not exceed the threshold value.

The sensors 80 may also include a sensor 206 (e.g., a two-dimensional scanner) that measures a profile of the can 46. In particular, the sensor 206 may scan the curved portion 62 and/or the planar portion 60 of the can 46 and provide feedback to the battery housing generation system 70 indicative of locations of the transition point 110 of the can 46 and the ZPD 112 of the can 46. As described herein, the transition point 110 may include a location along the curved portion 62 of the can 46 at which the curved portion 62 begins to curve in different direction (e.g., reflects relative to another portion of the can 46). The ZPD 112 may include a location along the can 46 wherein the can 46 begins to extend generally straight. For example, the ZPD 112 may include a tangent point of the curved portion 62 and/or an end of the curved portion 62.

Upon identifying the ZPD 112, the battery housing generation system 70, via the welding system 76, may determine a location of the weld seam 140 along the planar portion 60 of the can 46 and the outer portion 64 of the cover 48. For example, the welding system 76 may provide a predefined weld path for the welder 86 along the planar portion 60 of the can 46 and the outer portion 64 of the cover 48. The welding system 76 may adjust the predefined weld path based on the location of the ZPD 112 to generate a new weld location. For example, the welding system 76 may determine a location of an inner edge 120 of the weld seam 140 that is beyond the ZPD 112 and within a threshold distance of the ZPD 112. The welding system 76 may produce the weld seam 140 to couple the can 46 and the cover 48 while the can 46 and the cover 48 are disposed on the platform 200. Accordingly, the battery housing generation system 70, via the welding system 76, may produce the flange 130 of the housing 42. Thereafter, the battery housing generation system 70, via the cutting system 78, may cut the flange 130, such as beyond the weld seam 140 or along the weld seam 140.

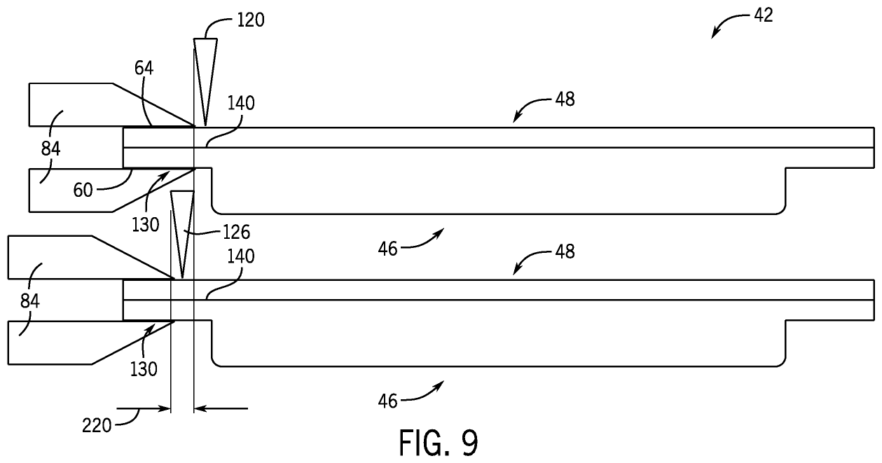

FIG. 9 is a side view of the can 46 and the cover 48 of FIG. 2 clamped to one another illustrating movement of the clamps 84 for welding the can 46 and the cover 48 and cutting the flange 130 formed upon welding the can 46 and the cover 48 via the battery housing generation system 70 of FIG. 3, according to embodiments of the present disclosure. In particular, the battery housing generation system 70, via the welding system 76, may weld the planar portion 60 of the can 46 and the outer portion 64 of the cover 48 to one another based on the ZPD 112 of the can 46, as indicated by the inner edge 120 of the weld seam 140, to form the flange 130. As described herein, the weld seam 140 may extend along the flange 130. During welding of the can 46 and the cover 48, the clamps 84 may secure the can 46 and the cover 48 in place.

After welding the can 46 and the cover 48 to form the flange 130, the battery housing generation system 70, via the positioning system 74, may move the clamps 84 along the planar portion 60 of the can 46 and the outer portion 64 of the cover 48 (e.g., along the flange 130). For example, the positioning system 74 may move the clamps by a distance 220. After movement of the clamps 84, the battery housing generation system 70, via the cutting system 78, may cut the flange 130 at the cut location 126. Accordingly, the battery housing generation system 70 may generate the housing 42 having the flange 130 (e.g., a reduced flange) using the ZPD 112 and the same clamps 84, such that the housing 42 may be produced at a single workstation that both welds and cuts the flange 130. In certain embodiments, the battery housing generation system 70 may measure the can 46 at the single workstation, such as by measuring and locating the transition point 110 and the ZPD 112.

In certain embodiments, the steps of measuring the can 46, welding the can 46 and the cover 48, and/or cutting the flange 130 may be performed at different workstations. For example, the battery housing generation system 70 may perform the steps of measuring the can 46 and welding the can 46 and the cover 48 to form the flange 130 at a first workstation, and the battery housing generation system 70 may perform the step of cutting the flange 130 at a second workstation.

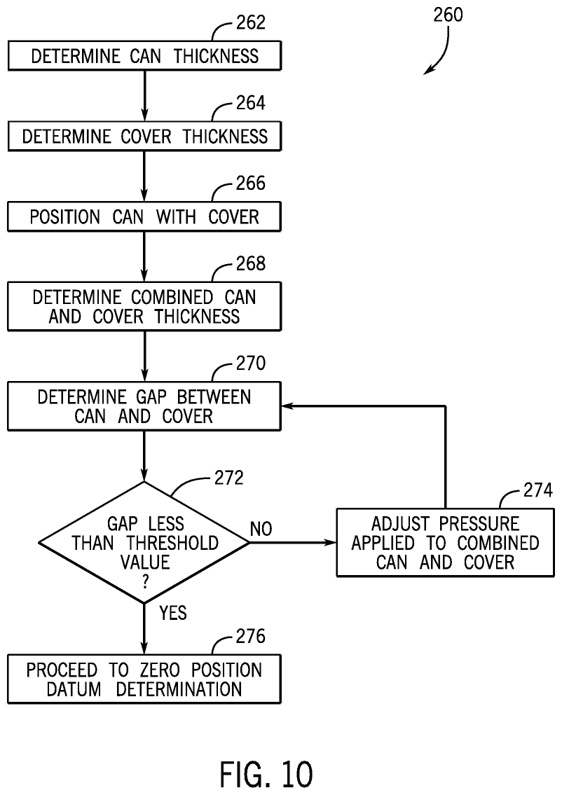

FIG. 10 is a flowchart of a method 260 of adjusting a pressure applied by the clamps 84 to the can 46 and the cover 48 of FIG. 2 that may be performed via the battery housing generation system 70 of FIG. 3, according to embodiments of the present disclosure. Any suitable device (e.g., a controller) that may control components of the battery housing generation system 70, such as the processor 71, may perform the method 260. In some embodiments, the method 260 may be implemented by executing instructions stored in a tangible, non-transitory, computer-readable medium, such as the memory 72, using the processor 71. For example, the method 260 may be performed at least in part by one or more software components, such as an operating system of the battery housing generation system 70, one or more software applications of the battery housing generation system 70, and the like. While the method 260 is described using steps in a specific sequence, it should be understood that the present disclosure contemplates that the described steps may be performed in different sequences than the sequence illustrated, and certain described steps may be skipped or not performed altogether.

In process block 262, the processor 71 determines the thickness 162 of the planar portion 60 of the can 46. In process block 264, the processor 71 determines the thickness 182 of the outer portion 64 of the cover 48. For example, the processor 71 may, via the measuring system 73, receive feedback indicative of the thickness 162 and the thickness 182 from the displacement sensors 170 (e.g., one-dimensional displacement sensors).

In process block 266, the processor 71 positions the can 46 with the cover 48. For example, the processor 71, via the positioning system 74 and/or the centering mechanism 82, may center the cover 48 over the can 46. In certain embodiments, the can 46 may be disposed on the cover 48, such that the processor 71, via the positioning system 74 and/or the centering mechanism 82, may center the can 46 over the cover 48.

In process block 268, the processor 71 determines the thickness 202 of the planar portion 60 of the can 46 and the outer portion 64 of the cover 48 while disposed together. For example, the processor 71, via the measuring system 73, may receive feedback indicative of the thickness 202 (e.g., a combined thickness) of the planar portion 60 of the can 46 and the outer portion 64 of the cover 48 from the sensor 204.

In process block 270, the processor 71 determines the gap 100 between the planar portion 60 of the can 46 and the outer portion 64 of the cover 48. For example, the processor 71, via the measuring system 73 and/or the positioning system 74, may determine the gap based on the thickness 162 of the planar portion 60 of the can 46, the thickness 182 of the outer portion 64 of the cover 48, and the thickness 202 of the planar portion 60 of the can 46 and the outer portion 64 of the cover 48 while disposed together. In particular, by subtracting the thickness 162 (e.g., a value of the thickness 162) and the thickness 182 (e.g., a value of the thickness 182) from the thickness 202 (e.g., a value of the thickness 202), the processor 71 may determine the gap 100 (e.g., a value of the gap 100).

In process block 272, the processor 71 determines whether the gap 100 exceeds a threshold value. Ensuring that the gap 100 does not exceed the threshold value may enable the can 46 and the cover 48 to maintain a hermetic seal of a cavity between the can 46 and the cover 48 once welded. For example, the threshold value may generally correspond to a maximum gap between the planar portion 60 of the can 46 and the outer portion 64 of the cover 48 that may be reliably sealed once welded.

In process block 274, the processor 71 adjusts the pressure applied to the can 46 and the cover 48 by the clamps 84 in response to determining that the gap 100 exceeds the threshold value. For example, the processor 71, via the positioning system 74, may adjust the pressure applied by the clamps 84. The adjusted pressure (e.g., increased pressure) applied by the clamps 84 may reduce the gap 100. The processor 71 may return to process block 272 and determine whether the reduced gap 100 exceeds the threshold value. In response to determining that the gap 100 exceeds the threshold value, the processor 71 may repeat process block 274. In certain embodiments, the processor 71 may determine an amount of pressure (e.g., the adjustment to the pressure) to be applied by the clamps 84 to the can 46 and the cover 48 based on a size of the gap 100. For example, in response to the gap 100 being three times the threshold value, the adjustment to the pressure may be greater than if the gap 100 is two times the threshold value.

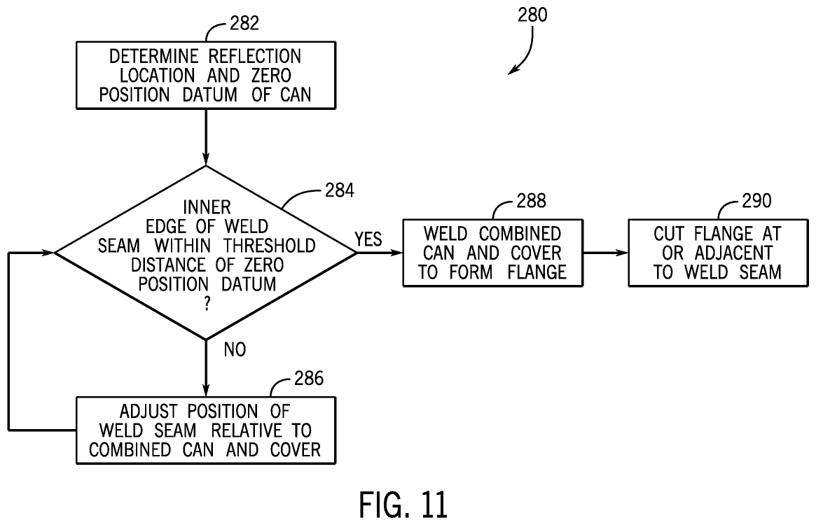

In process block 276, the processor 71 proceeds to the zero position datum (e.g., the ZPD 112) determination in response to determining that the gap 100 does not exceed the threshold value. In this manner, the method 260 enables the processor 71 to adjust a pressure applied by the clamps 84 to the can 46 and the cover 48 via, for example, the battery housing generation system 70. The zero position datum determination is described in reference to FIG. 11.

FIG. 11 is a flowchart of a method 280 of welding the can 46 and the cover 48 of FIG. 2 and cutting the flange 130 formed by the can 46 and the cover 48 via the battery housing generation system 70 of FIG. 3, according to embodiments of the present disclosure. Any suitable device (e.g., a controller) that may control components of the battery housing generation system such as the processor 71, may perform the method 280. In some embodiments, the method 280 may be implemented by executing instructions stored in a tangible, non-transitory, computer-readable medium, such as the memory 72, using the processor 71. For example, the method 280 may be performed at least in part by one or more software components, such as an operating system of the battery housing generation system 70, one or more software applications of the battery housing generation system 70, and the like. While the method 280 is described using steps in a specific sequence, it should be understood that the present disclosure contemplates that the described steps may be performed in different sequences than the sequence illustrated, and certain described steps may be skipped or not performed altogether.

In process block 282, the processor 71 determines the transition point 110 and the ZPD 112 of the can 46. For example, the processor 71, via the measuring system 73 and/or the sensor 206, may identify locations of the transition point 110 and the ZPD 112 along a profile of the can 46. In particular, the processor 71 may receive feedback from the sensor 206 and determine the locations of transition point 110 and the ZPD 112 based on the feedback.

In process block 284, the processor 71 determines whether the inner edge 120 of the weld seam 140 is within a threshold distance of the ZPD 112. For example, the processor 71 may compare a predefined weld path identifying an initial location of the inner edge 120 of the weld seam 140 to the ZPD 112. In response to determining that the inner edge 120 of the weld seam 140 exceeds the threshold distance of the ZPD 112, the processor 71 proceeds to process block 286. In response to determining that the inner edge 120 of the weld seam 140 is within the threshold distance of the ZPD 112, the processor 71 proceeds to process block 288.

In process block 286, the processor 71 adjusts the position of the weld seam 140 relative to the can 46 and the cover 48, such that the inner edge of the weld seam 140 is within the threshold distance of the ZPD 112. For example, the processor 71 may adjust the position of the weld seam via the welding system 76. Ensuring that the inner edge 120 of the weld seam 140 is within the threshold distance of the ZPD 112 may reduce a size of a flange 130 formed by the planar portion of the can 46 and the outer portion 64 of the cover 48 once welded.

In certain embodiments, the processor 71 may determine whether the inner edge 120 of the weld seam 140 is beyond the ZPD 112 along the planar portion 60 of the can 46 and the outer portion 64 of the cover 48 (e.g., in addition to determining whether the inner edge 120 is within a threshold distance of the ZPD 112). Ensuring that the inner edge 120 of the weld seam 140 is beyond the ZPD 112 may enable the can 46 and the cover 48 to maintain the hermetic seal of the battery 40.

In process block 288, the processor 71, via the welding system 76, welds the can 46 and the cover 48 to form the weld seam 140 and the flange 130. In process block 290, the processor 71, via the cutting system 78, cuts the flange 130 along the weld seam 140 or adjacent to the weld seam 140 (e.g., beyond the weld seam 140, on a side of the weld seam 140 opposite the ZPD 112). Accordingly, the battery housing generation system 70, via the processor 71, may produce the housing 42 with the flange 130 having a reduced size, such that the reduced size of the flange 130 enables an increased interior volume of the housing 42 and an increased volumetric energy density of the battery 40. In this manner, the method 280 enables the processor 71 to weld the can 46 and the cover 48 and cut the flange 130 formed by the can 46 and the cover 48 via, for example, the battery housing generation system 70.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A battery housing, comprising:
a cover; and
a can comprising:
a curved portion having a transition point; and
a planar portion extending from the curved portion, wherein the planar portion is coupled to the cover via a weld seam to form a flange, and wherein a distance between the transition point of the curved portion and an outermost end of the flange is equal to or less than 300 microns.

2. The battery housing of claim 1, wherein an additional distance between the transition point of the curved portion and an inner edge of the weld seam is equal to or less than 180 microns.

3. The battery housing of claim 1, wherein an additional distance between the transition point of the curved portion and an outer edge of the weld seam is equal to or less than 280 microns.

4. The battery housing of claim 1, wherein the weld seam extends to the outermost end of the flange.

5. The battery housing of claim 1, wherein an additional distance between an outer edge of the weld seam and the outermost end of the flange is equal to or less than 20 microns.

6. The battery housing of claim 1, wherein the weld seam extends along a perimeter of the battery housing.

7. The battery housing of claim 1, wherein the cover is planar.

8. The battery housing of claim 1, wherein a cavity formed between the cover and the can is configured to receive electrode material.

9. A battery, comprising:
a cover;
a can comprising a curved portion having a transition point, wherein the cover and the can form a flange, and wherein a distance between the transition point of the curved portion and an outermost end of the flange is equal to or less than 300 microns; and
electrode material disposed within a cavity formed between cover and the can.

10. The battery of claim 9, wherein the can comprises an aperture configured to receive the electrode material, and wherein the battery comprises a plug sealing the aperture.

11. The battery of claim 9, wherein the cover and the can are coupled via a weld seam at the flange.

12. The battery of claim 11, wherein an additional distance between the transition point of the curved portion and an inner edge of the weld seam is equal to or less than 180 microns.

13. The battery of claim 11, wherein an additional distance between the transition point of the curved portion and an outer edge of the weld seam is equal to or less than 280 microns.

14. The battery of claim 11, wherein the weld seam extends to the outermost end of the flange.

15. The battery of claim 9, wherein the cover is planar.

16. The battery of claim 9, comprising a positive terminal and a negative terminal, wherein each of the positive terminal and the negative terminal are coupled to the electrode material.

17. A battery, comprising:
a housing comprising:
a curved portion having a transition point; and
a flange extending from the curved portion, wherein a distance between the transition point of the curved portion and an outermost end of the flange is equal to or less than 300 microns; and
electrode material disposed within the housing.

18. The battery of claim 17, wherein the housing is configured to be disposed in a wireless electronic device.

19. The battery of claim 17, wherein the flange comprises a weld seam.

20. The battery of claim 19, wherein an additional distance between the transition point of the curved portion and an inner edge of the weld seam is equal to or less than 180 microns.
